(19) United States
(12) Patent Application Publication
(10) Pub. No.: US 2013/0047106 A1
(43) Pub. Date: Feb. 21, 2013

(54) OBJECT RELOCATION DEVICE, METHOD AND PROGRAM FOR RELOCATING MAP OBJECT

(71) Applicants: Kotoyu Sasayama, Tokyo (JP); Makoto Otsuru, Tokyo (JP); Tsuyoshi Sempuku, Tokyo (JP); Yoko Sano, Tokyo (JP); Takeyuki Hori, Tokyo (JP)

(72) Inventors: Kotoyu Sasayama, Tokyo (JP); Makoto Otsuru, Tokyo (JP); Tsuyoshi Sempuku, Tokyo (JP); Yoko Sano, Tokyo (JP); Takeyuki Hori, Tokyo (JP)

(73) Assignee: Mitsubishi Electric Corporation, Tokyo (JP)

(21) Appl. No.: 13/643,606

(22) PCT Filed: May 26, 2010
(86) PCT No.: PCT/JP2010/003529

§ 371 Date: Oct. 26, 2012

(51) Int. Cl. G06F 3/048; G06F 17/30

(52) U.S. Cl. 715/766

(57) ABSTRACT

Evaluation values are set for placement candidate positions as indices for determining appropriate positions as positions for relocating objects; among from the placement candidate positions set for an object that comes later in an order of display, the placement candidate position that is set by an evaluation value indicative of being most appropriate as a position to be relocated is extracted, and whether or not the object that comes later in the order of display is adapted to a likely placement at the corresponding placement candidate position is determined; and the object is relocated at the placement candidate position that is determined the likely placement and drawn.

### TECHNICAL FIELD

The present invention relates to an object relocation device, and a method and a program for relocating map objects which are used in a map display device of a navigation system, and so on, and in which the objects are relocated to be viewed with ease.

### BACKGROUND ART

In a map display device such as a car navigation system, when a facility built-up area such as a city is displayed, a large number of map objects representing trademarks, character strings and the like may overlap each other, which makes it hard to view the map objects themselves. When the map object overlaps with the representation of roads or routes, there may also occur an inconvenience such that important information to be viewed on the map is hidden on a run of a vehicle.

In order to solve the aforementioned inconvenience, in the past, a technique has been proposed, which automatically places the map objects to positions where they do not overlap each other. For example, Patent Document 1 discloses a device in which a map object is slid along an auxiliary line drawn in the object provided that there is an enough space between the map object and another object, to thus make a research for a position that does not overlap the another map object.

However, in the conventional technique represented by Patent Document 1, an increase of the number of map objects to be placed limits a relocatable space thereof, which makes it hard to make a relocation without overlapping with the another map object.

For this reason, in the past, when there is no more space for relocating the map objects, it is necessary to repeat a series of processings in which the positions of the relocated objects are changed and then the overlapping between the objects is determined again.

In this manner, the positions for relocating all the map objects have to be determined, there is a need to make calculations for positioning again and again; thus, there is a problem such that a processing load required for the calculations becomes inevitably higher.

The present invention is made to solve the aforementioned problem, and an object of the invention is to provide an object relocation device capable of determining positions for relocating objects at a high speed by reducing the number of determining positions of placement of objects, a method of relocating map objects by the object relocation device applied to a map display, and a program for functioning a computer as the device.

### PRIOR ART DOCUMENTS

### Patent Documents

Patent Document 1: Japanese Patent Application Laid-open No. 2009-157574

### SUMMARY OF THE INVENTION

An object relocation device of the present invention is an object relocation device in which a plurality of objects are relocated at no overlapping positions and displayed, and includes: a database for storing the plurality of objects associated with an order of display; a placement candidate position setting unit for setting a placement candidate position for the object obtained from the database; an evaluation value setting unit for setting an evaluation value to the corresponding placement candidate position, the evaluation value being an index for determining an appropriate position as a position for relocating the object; a likely placement determining unit for extracting a placement candidate position that is set by an evaluation value indicative of being most appropriate as a position to be relocated, from among the placement candidate positions that are set for the object that comes later in the order of display, and determining whether or not the object that comes later in the order of display is adapted to a likely placement at the corresponding placement candidate position; and a drawing unit for relocating the object at the placement candidate position that is determined the likely placement by the likely placement determining unit and making a drawing.

According to the invention, the evaluation value that is the index for determining the appropriate position as the position for relocating the object is set to the placement candidate positions; from among the placement candidate positions set for the map objects that come later in the order of display, the placement candidate position in which the evaluation value indicative of being most appropriate as the position to be relocated is set is extracted, and then whether or not the map object that comes later in the order of display is adapted to the likely placement at the corresponding placement candidate position is determined; and the map object is relocated to the placement candidate position that is determined the likely placement, and drawn.

In doing so, the relocated position of a not-placed-yet map object can be determined without moving a map object placed earlier in the order of display (placed map object), and therefore, the time required for calculations of placement of the objects is linear to the number of the objects, which enables to determine the relocated position at a high speed.

### BRIEF DESCRIPTION OF THE DRAWINGS

FIG. 1 is a block diagram illustrating the configuration of an object relocation device according to Embodiment 1 of the present invention.

FIG. 2 is a flowchart showing the flow of operations by the object relocation device of Embodiment 1.

FIG. 3 is a diagram showing one example of the data of the map objects stored in a map database.

FIG. 4 is a diagram showing another example of the data of the map objects stored in the map database.

FIG. 5 is a diagram showing a display example of map objects on a map screen.

FIG. 6 is a diagram showing an example of a setting of placement candidate positions of a map object.

FIG. 7 is a diagram showing a circular movable area.

FIG. 8 is a diagram showing an example of a setting of placement candidate positions.

FIG. 9 is a diagram showing examples of movable areas.

FIG. 10 is a diagram for explaining the evaluation of placement candidate positions in accordance with the positional relationship between map objects.

FIG. 11 is a diagram showing a table of display scales corresponded with thresholds.

FIG. 12 is a diagram showing a flow having a series of steps that calculates evaluation values of placement candidate positions with respect to map objects and moves the map object to the placement candidate position having the largest evaluation value.

FIG. 13 is a flowchart showing the flow of operations by an object relocation device of Embodiment 2.

FIG. 14 is a diagram showing one example of the resetting of the placement candidate positions.

### BEST MODE FOR CARRYING OUT THE INVENTION

In the following, in order to explain the present invention in more detail, embodiments of the invention will be described with reference to the accompanying drawings.

### Embodiment 1

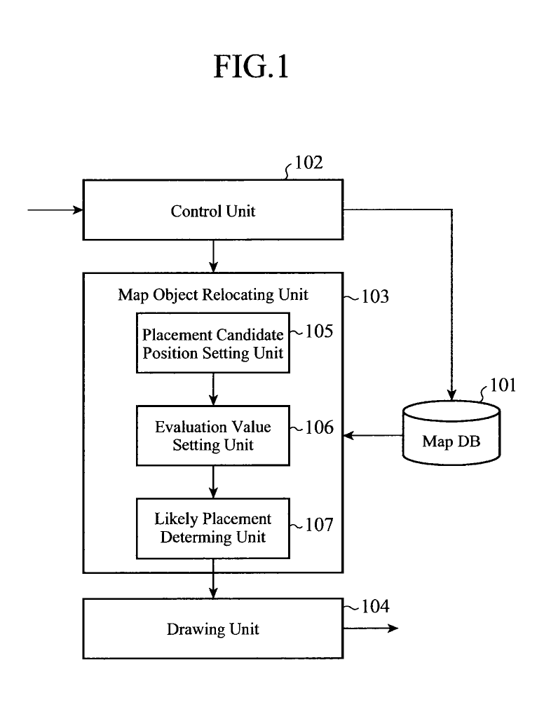

FIG. 1 is a block diagram illustrating the configuration of an object relocation device according to Embodiment 1 of the invention, and shows an instance in which the object relocation device of the invention is applied to a map display device of a navigation system. Referring to FIG. 1, the object relocation device of Embodiment 1 includes a map database (hereinafter, referred to as “map DB”) 101, a control unit 102, a map object relocating unit 103, and a drawing unit 104.

The map DB 101 is a database for storing map data such as map objects, and configured in a memory device mounted in a computer that functions as the object relocation device, or in another computer connectable for communication with the above computer.

Specifically, the above memory device may be, for example, a hard disk device, an external memory medium and a drive for playing the medium, a semiconductor memory medium, and the like.

The control unit 102 is a constitutional unit for controlling the processing for a map display, and executes a processing of, for example, obtaining a map object to be placed within a display area on a screen from the map DB 101 and providing the map object to the map object relocating unit 103.

The drawing unit 104 is a constitutional unit for drawing the map object at the relocated position determined by the map object relocating unit 103.

The map object relocating unit 103 is a constitutional unit for determining a position for relocating the map object obtained from the map DB 101 by the control unit 102, and includes a placement candidate position setting unit 105, an evaluation value setting unit 106, and a likely placement determining unit 107.

The placement candidate position setting unit 105 is a constitutional unit for setting placement candidate positions in the vicinity of the placed position of the map object obtained from the map DB 101 by the control unit 102.

The evaluation value setting unit 106 is a constitutional unit for setting an evaluation value for the placement candidate position that is set by the placement candidate position setting unit 105.

The likely placement determining unit 107 is a constitutional unit for determining whether or not the corresponding map object can be relocated to the placement candidate position where the highest evaluation value is set by the evaluation value setting unit 106, from among the placement candidate positions set in the vicinity of the map object.

It is noted that when an object relocation processing program complying with the content of the invention is run in a computer, the control unit 102, the map object relocating unit 103, and the drawing unit 104 can be implemented in the corresponding computer as a specific means in which hardware and software cooperate with each other. In other words, the above object relocation processing program is configured with a program module describing the functions of the constitutional units, which are represented by the control unit 102, the map object relocating unit 103 (the placement candidate position setting unit 105, evaluation value setting unit 106, and likely placement determining unit 107), and the drawing unit 104.

Next, the operation will be described.

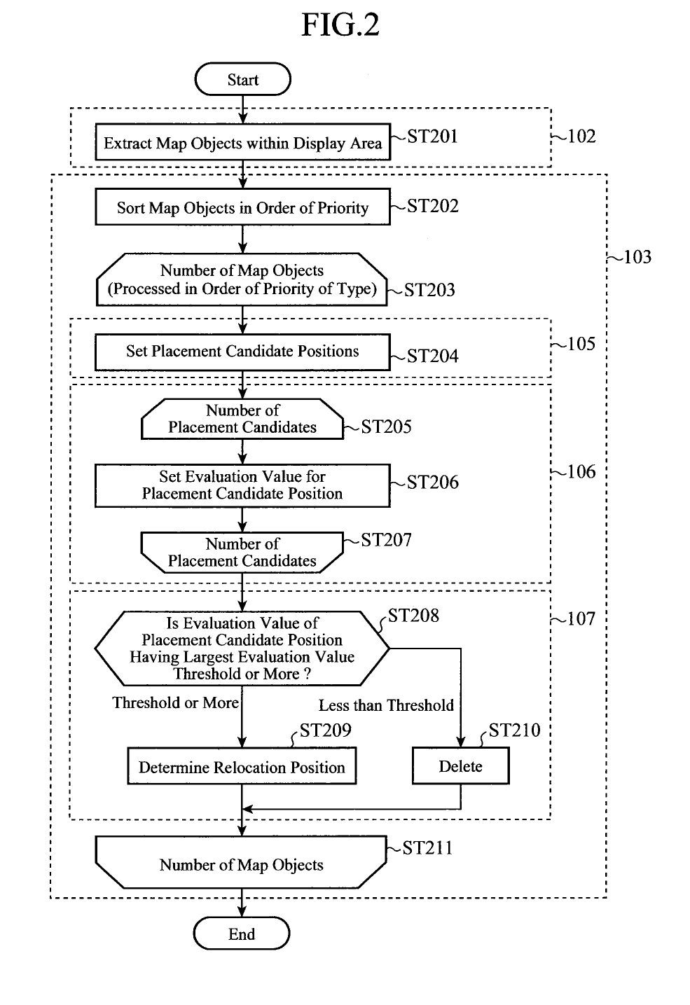

FIG. 2 is a flowchart showing the flow of operations by the object relocation device of Embodiment 1, and shows the operations by the control unit 102 and the map object relocating unit 103.

In FIG. 2, the processing of a section enclosed with a broken line and denoted by reference numeral 102 is carried out by the control unit 102, and the processing of a section enclosed with a broken line and denoted by reference numeral 103 is carried out by the map object relocating unit 103.

Then, the processing of a section enclosed with a broken line and denoted by reference numeral 105 is carried out by the placement candidate position setting unit 105 of the map object relocating unit 103, the processing of a section enclosed with a broken line and denoted by reference numeral 106 is carried out by the evaluation value setting unit 106, and the processing of a section enclosed with a broken line and denoted by reference numeral 107 is carried out by the likely placement determining unit 107.

First, the control unit 102 extracts map objects within a display area from the map database 101 (step ST201). The map objects extracted at step ST201 are relocated through the processings from step ST202 to step ST210 by the map object relocating unit 103.

It is noted that the processings from step ST203 to step ST211 are carried out with respect to the map objects in the order of display priority. Here, the display priority refers to values indicative of the order in which the map objects are to be displayed on the map screen. For example, in order to grasp the position of a vehicle, or operate safely the vehicle, values that determine the order of the map objects to be drawn attention on the map screen by the user are used as the display priority.

Then, the map objects sorted in the order of display priority at step ST202 are input to the placement candidate position setting unit 105. An interface unit between the map DB 101 and the map object relocating unit 103, for example, sorts the map objects extracted by the control unit 102 in the order of display priority. Incidentally, the time required for the sorting can be shortened when the map objects in the order of display priority are sorted on an off-line operation.

However, the display priority of the map objects is not changed even if the display area is changed.

Namely, the display priority of the map objects is uniquely determined in advance for each map object.

For example, map objects serving as landmarks for a drive like Tokyo Tower, Tokyo Dome, and so on, map objects having a higher degree of recognition, or map objects including necessary information for driving users such as gas station are given a higher display priority. Traffic signals and so on relating to safety on a drive may also be given a high display priority.

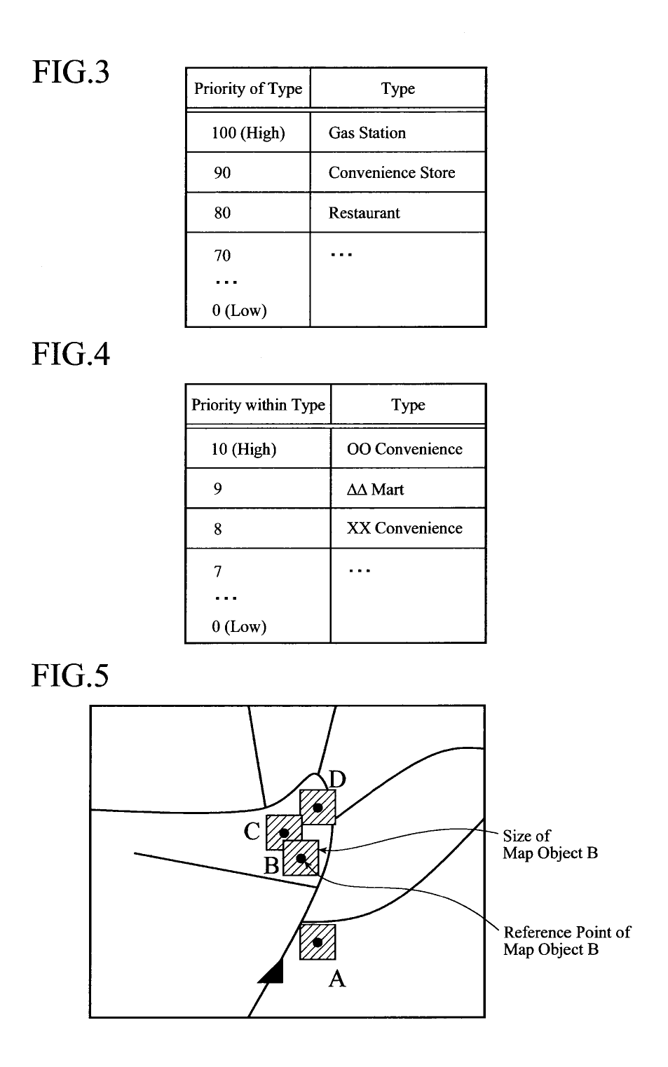

FIG. 3 is a diagram showing one example of the data of the map objects stored in the map database, and shows the types of the map objects and the display priorities set for the types. As shown in FIG. 3, the display priory is assigned to each type of the map objects.

The types of the map objects are the ones of features represented as the map objects, and include gas stations, convenience stores, restaurants, and the like. In FIG. 3, the gas stations, which are of the highest interest for users in a long-distance service, are given a display priority of 100.

FIG. 4 is a diagram showing another example of the data of the map objects stored in the map database, and shows, among the types of the map objects in FIG. 3, the types of the map objects sorted into the “convenience store” (names of the stores) and the display priorities set for these respective types. In this way, the map DB 101 is sorted into the respective categories of the features represented by the map objects, and has a hierarchical data structure ranging from top categories to map objects representing detailed features.

Note that in FIG. 4 the display priority may be set otherwise in accordance with the need of the user: for example, a higher display priority is given to OO Convenience Store, since the OO Convenience Store has a higher degree of recognition than that of ΔΔ Mart. In FIG. 3 and FIG. 4, it is configured that the higher numerical value of the display priority give precedence to the order of the display. In this way, the display priority is set for each map object in advance.

Further, the reasons why the processings from step ST203 to step ST211 are performed in the order of the display priority are mentioned below:

This is because when a relocation is carried out so that the map objects do not overlap each other, it is to be ensured that the map object having a higher display priority is displayed precisely.

In other words, in an object relocating algorithm according to Embodiment 1, as described later, a relocation-impossible map object is subjected to a deleting processing at step ST210; however, since the map object in which a position to be relocated is once determined is not moved, the map objects to be placed later are more likely to be deleted.

Accordingly, when the processing is carried out in the order of the display priority, the map objects drawing the user's attention are first placed, which enables to reduce the possibility thereof to be deleted.

Next, at step ST204, the placement candidate position setting unit 105 sets placement candidate positions for the map objects extracted at step ST201. A process for setting the placement candidate positions will be described below with reference to FIG. 5 to FIG. 9.

FIG. 5 is a diagram showing a display example of map objects on a map screen, and shows a state before the map objects are relocated. In the example shown in FIG. 5, map objects A to D extracted at step ST201 are placed at reference points indicated by black circles in the map objects, and the map objects B and C overlap each other, and the map objects C and D overlap each other.

The reference points refer to coordinate points in which the center points of the map objects are positioned on the map screen.

Specifically, the map objects are image data such as bit maps or vector data such as scalable fonts, and therefore the reference points can also be rephrased as center points of the corresponding figures where the figures of the map objects defined by the image data or vector data are placed.

The map object is represented as a figure provided with a breadth in accordance with a certain rule on the basis of the reference point. In the example of FIG. 5, the map object is represented by a rectangle provided with a certain breadth in height and width with respect to the reference point. It is noted that the rectangle representing the map object may be other polygons such as trapezoid, or may be represented by a circle.

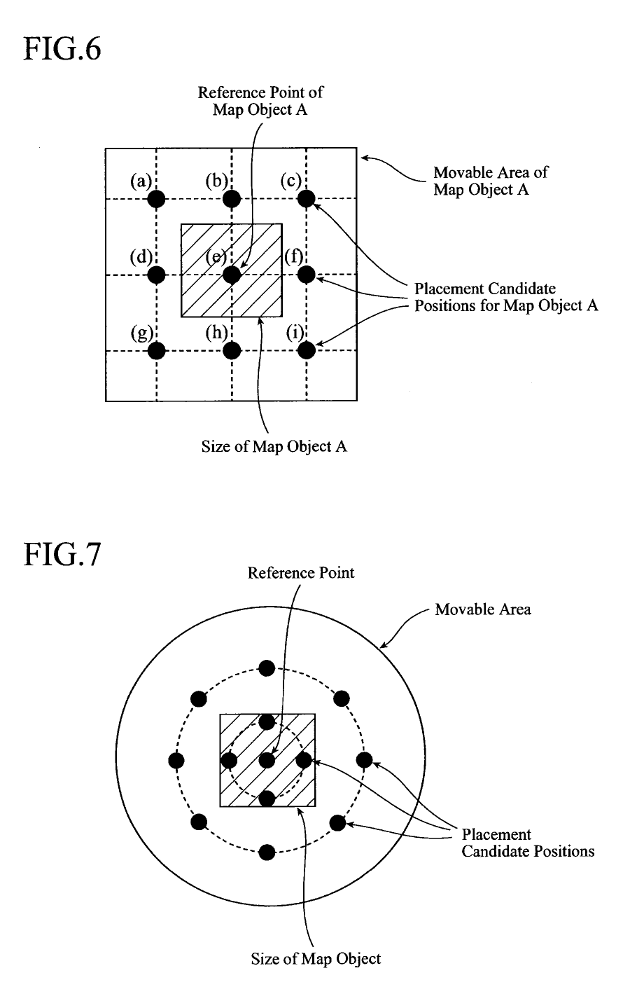

FIG. 6 is a diagram showing an example of a setting of placement candidate positions of a map object. In the example of FIG. 6, placement candidate positions set around the reference point of map object A are shown.

The movable area shown in FIG. 6 is divided in a grid; the reference point is positioned at the central grid point, and the grid points therearound correspond to the placement candidate positions. The center of the movable area need not be the reference point. For example, the reference point of the map object may be at (a), and the placement candidate positions may be grid points (b) to (i).

In FIG. 6, the reference point is set at (e), and the placement candidate positions are set at (a) to (d) and (f) to (i); however, it is also possible that the reference point is set at the placement candidate positions. Namely, the placement candidate positions may be set at (a) to (i). The reference point of the map object is moved to one of the placement candidate positions after the processing of relocation at step ST209.

It is noted that the placement candidate position refers to a coordinate serving as a candidate of a position where the reference point of the map object is moved upon the relocation. Though the grid points within the movable area are defined as the placement candidate positions in the example of FIG. 6, the number of the placement candidate positions or a rule for setting the placement candidate positions may be proper to each of the map objects. Further, as long as the number of the placement candidate positions is one place or more, it may be set at any number of places.

Further, the movable area may be an area surrounding a set of the figures of the map objects such that the map objects are placed at all the placement candidate positions that are set around the reference point of a map object.

FIG. 7 is a diagram showing a circular movable area. In the example shown in FIG. 7, the placement candidate positions are set on concentric circles around the reference point of a map object. In this instance, the movable area is a circular area that circumscribes the figures of the map objects, when the map objects are placed at all the placement candidate positions on the outermost concentric circle.

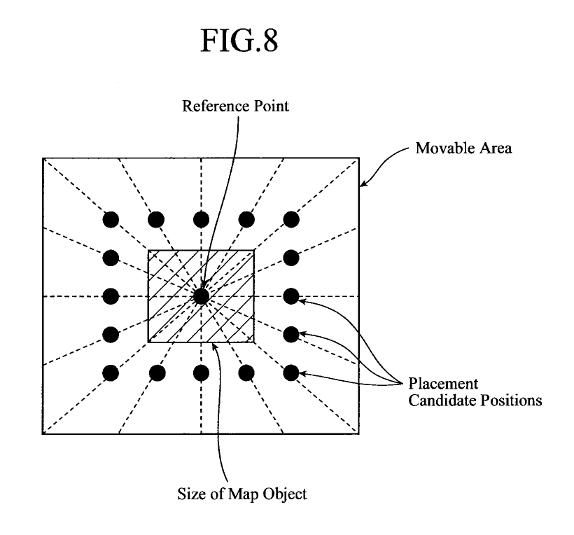

FIG. 8 is a diagram showing an example of a setting of placement candidate positions. The example of FIG. 8 shows an instance where placement candidate positions are set on a plurality of line segments radially drawn from the center (reference point) of a rectangular movable area.

As mentioned above, the movable area may be an area surrounding a set of the figures of the map objects that is configured in such a manner that the map objects are placed at all the placement candidate positions that are set around the reference point of the map object, and can be simplified to a figure such as square and circle.

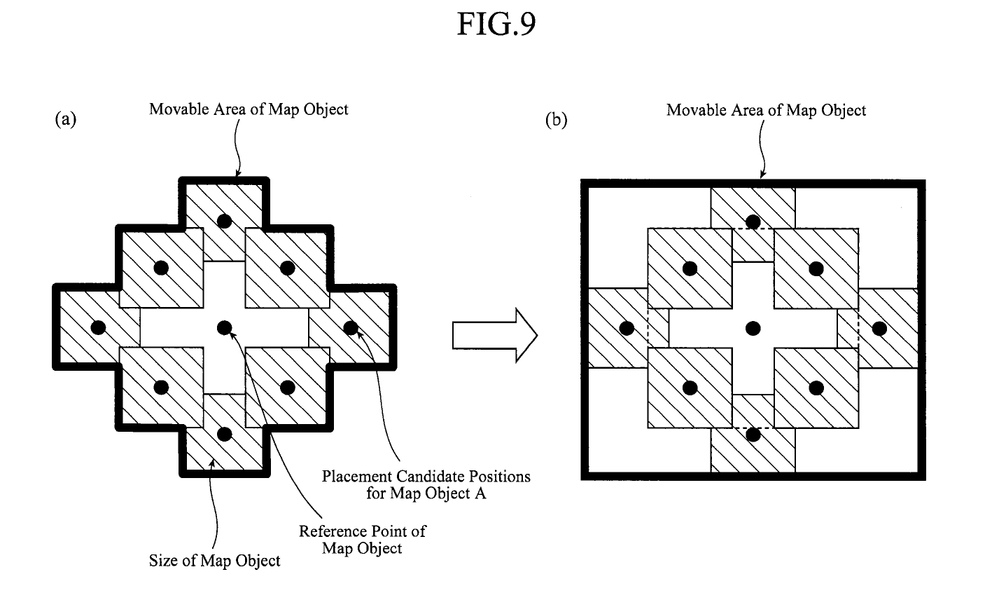

FIG. 9 is a diagram showing examples of movable areas. The movable area shown in FIG. 9(a) is an area that connects the line segments facing the outsides of the figures of the map objects placed at all the placement candidate positions around the reference point of a map object, providing an area having a complex polygon.

Then, FIG. 9(b) is an example in which the movable area of FIG. 9(a) is simplified, and shows a rectangular movable area containing only the outermost line segments in the boundary of the area, in the figures of the map objects placed at all the placement candidate positions around the reference point of the map object.

The movable area can be configured as both a complex polygon and a simple figure depending on how the boundary line is drawn (bold line in FIG. 9), even if the internal settings of the placement candidate positions are the same.

Furthermore, the movable area and the number of the placement candidate positions can be arbitrarily set depending on the type, density and/or the like of the map objects.

In a region dense with map objects on a map screen, the movable area can be expanded without changing the number of the placement candidate positions, and the number of the placement candidate positions can also be increased without changing the size of the movable area.

For example, in consideration of the positional relationship between the reference points of the map objects to be processed successively, the placement candidate position setting unit 105 increases the number of the placement candidate positions without changing the size of the movable area when the density is not less than a certain degree of density, or enlarges the movable area without changing the number of the placement candidate positions when the density is less than a certain degree of density.

Next, in the processings from step ST205 to step ST207, the evaluation value setting unit 106 selects the most appropriate position for relocating the map object from among the placement candidate positions that are set at step ST204.

It is noted that an appropriate position as a position for relocating the map object contains a condition complying with a certain display configuration, without mentioning no overlapping with other map objects.

The display configuration is a manner of display representing a positional relationship based on the type of the map object, a positional relationship between the map objects, and a positional relationship proper to specific map objects.

For example, the following are included: the map object within a certain distance from an intersection between major roads such as national and prefectural roads is placed as close to the intersection as possible; the map object is placed so as not to overlap a route; and the positional relationship between the map objects before the relocation (map object A being at upper right, map object B being at lower left, and so on) is maintained after the relocation.

The evaluation value setting unit 106 evaluates the placement candidate positions using an evaluation function so as to determine whether or not the placement candidate positions set at step ST204 are appropriate for positions to be relocated. Specifically, evaluation values for the respective placement candidate positions are calculated using the evaluation function, and the placement candidate position having the largest evaluation value is determined an appropriate position as a position to be relocated.

It is noted that depending on how the evaluation function is made, the placement candidate position having the smallest evaluation value can be set as the appropriate position as the position to be relocated.

Namely, the evaluation value is an index for determining the appropriate position as the position to be relocated out of the plurality of placement candidate positions, and a value determining quantitatively the evaluation having a nice-looking position from a user's side when the object is placed. In addition, the evaluation value is determined taking account of a positional relationship with a not-placed-yet object or obstacle (route etc.), in addition to an overlapping relationship with a placed object.

As the evaluation function, for example, a weighted linear sum P as shown in Equation (1) or Equation (2) below is specified. It is noted that in Equations (1) and (2) below, Db represents the distance from the reference point of the map object to the placement candidate position (a candidate position for displaying the object). Dc represents a distance between an intersection and the placement candidate position in the case where the map object is located in the vicinity of the intersection.

In addition, Ob indicates presence/absence of an overlapping between the placed map object and the not-placed-yet map object. For example, the parameter Ob is “0” if the overlapping is present therebetween, and the parameter Ob is “1” if not.

Op indicates presence/absence of an overlapping between the movable area of the not-placed-yet map object and the placed map object. For example, the parameter Op is “0” if the overlapping is present therebetween, and the parameter Op is “1” if not.

Pb indicates the overlapping probability between the placed map object and the not-placed-yet map object, and Pp indicates the overlapping probability between the movable area of the not-placed-yet map object and the placed map object. The settings of these overlapping probabilities Pb and Pp allows to determine relocated positions with tolerating a little overlapping. Further, the overlapping probabilities Pb and Pp are set based on, for example, an overlapping area or dispersity of the positions of the objects.

Coefficients w1, w2, w3, and w4 are weight coefficients for the respective parameters, and the positional relationship between the not-placed-yet map object and the placed map object is defined by the weight coefficients. It is noted that a display allowing the overlapping between the objects is also made depending on the value of the parameter Ob.

P=w1×Db+w2×Dc+w3×Ob×Pb+w4×Op×Pp (1)

P=Ob×Pb×(w1×Db+w2×Dc+w4×Op×Pp) (2)

Using as a parameter the result of the determination of the overlapping with the placed map object allows to place the not-placed-yet map object without moving a map object having a higher display priority. When the above evaluation function is set such that the evaluation value regarding the placement candidate position overlapping with the placed map object is lowered, the map object is prevented from being relocated to the placement candidate position. Therefore, it is possible to prevent the overlapping with the placed map object.

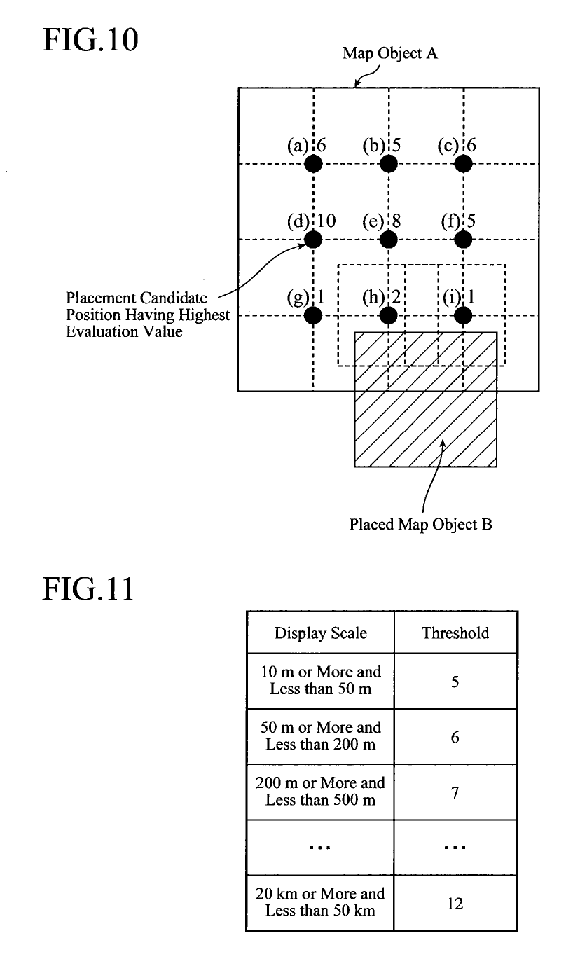

FIG. 10 is a diagram for explaining the evaluation of placement candidate positions in accordance with the positional relationship between map objects. In the example of FIG. 10, placement candidate positions (a) to (i) are set for a map object A, and a placed map object B is present on a map screen.

For example, when the map object A is placed, evaluation values of “2” and “1” are set at the placement candidate positions (h) and (i) overlapping with the map object B, respectively. Also, the largest evaluation value of “10” is set at the placement candidate position (d) not overlapping with the map object B and within a certain distance from the map object B.

Next, the likely placement determining unit 107 determines whether or not the evaluation value of the placement candidate position having the largest evaluation value is not less than a threshold in accordance with the display scale of the map (step ST208). At this point, if the corresponding evaluation value of the placement candidate position having the largest evaluation value is the above threshold or more, the likely placement determining unit 107 determines the corresponding placement candidate position as a position to be relocated (step ST209).

On the other hand, if the corresponding evaluation value of the placement candidate position having the largest evaluation value is less than the above threshold, the likely placement determining unit 107 deletes the corresponding map object from drawing targets (step ST210). In other words, this map object is not drawn.

It is noted that the above threshold is a value indicating the upper limit of the evaluation values of the placement candidate positions to be deleted without the relocation of the map object, and is set by a value corresponding to the display scale of the map.

For example, the corresponding threshold is set lower in a detailed display scale thereof, and the corresponding threshold is set higher in a wide-area display scale thereof. In such a way, every time at step ST208, in the detailed display scale, the placement candidate position is more likely to be determined as a relocated position, so that many map objects (symbols) are to be drawn. Contrarily, in the wide-area display scale, the placement candidate position is less likely to be determined as a relocated position, so that the number of map objects to be drawn can be reduced.

FIG. 11 is a diagram showing a table that associate display scales with the above thresholds. As shown in FIG. 11, the likely placement determining unit 107 holds a data of the table that associates the display scales with the predetermined thresholds. The thresholds correspond to the plurality of display scales that can be set in the map display, respectively, and a specific display scale is uniquely determined by one threshold.

The likely placement determining unit 107 reads out the threshold corresponding to the present display scale of the map from the table data shown in FIG. 11, compares the corresponding threshold with the corresponding evaluation value of the placement candidate position having the largest evaluation value, and determines whether or not the evaluation value is the threshold or more. In FIG. 11, the thresholds are set to be lower as the display scale of the map is more detailed.

When the display scale is 10 m or more and less than 50 m (detailed display), it is assumed that the user wants detailed map information, so that the threshold is set lower (e.g., “5”) as shown in FIG. 11, to thus allow as many symbols as possible to be drawn.

On the other hand, when the scale is 20 km or more and less than 50 km (wide-area display) , it is good enough to obtain a general map, so that the threshold is set higher (e.g., “12”) to reduce the number of symbols to be drawn. In this way, it becomes possible to present the map display reflecting the user's intentions.

Incidentally, though the thresholds are indicated by the predetermined values in the example of FIG. 11, the corresponding relationship between the display scales and the thresholds may be defined by a function using the display scale and the threshold as parameters.

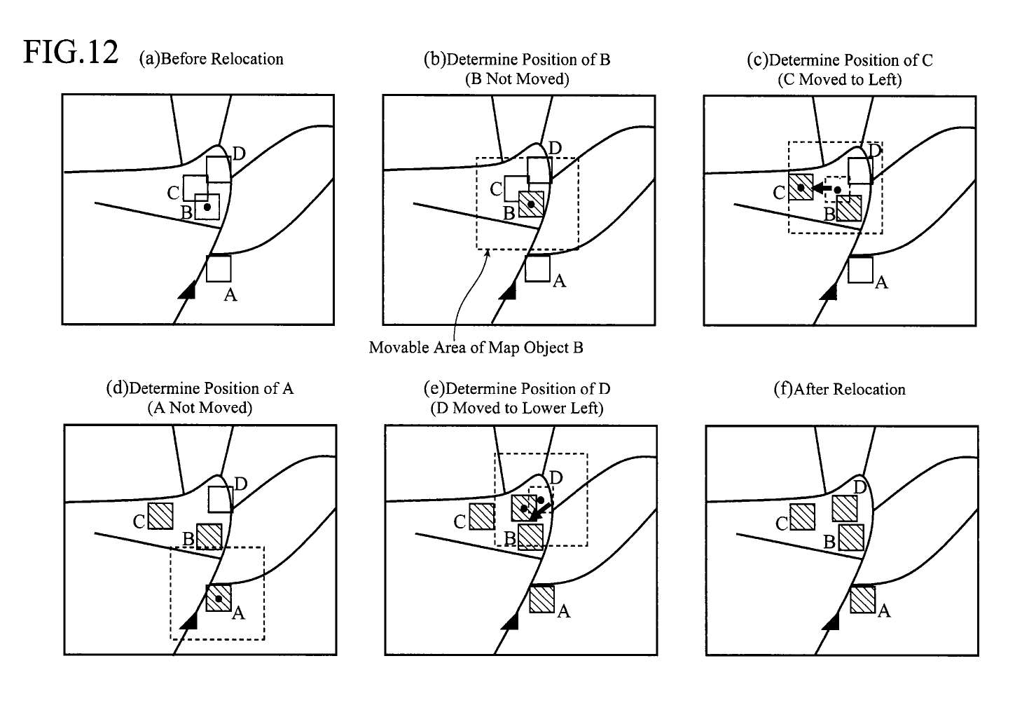

FIG. 12 is a diagram showing a flow having a series of steps that calculates evaluation values of placement candidate positions with respect to map objects, and moves the map object to the placement candidate position having the largest evaluation value. In FIG. 12(a), it is assumed that the display priory of map objects A to D is the order of B, C, A, and D. In this instance, the relocated positions thereof are determined in the order of the map objects B, C, A, and D.

First, in FIG. 12(b), the relocated position of the map object B having the highest display priority is determined. At this point, the placement candidate positions are set in the vicinity of the map object B at step ST204. Then, the evaluation values of the placement candidate positions are calculated using the evaluation function at step ST206.

Next, the evaluation values of all the placement candidate positions are calculated in the processings from step ST205 to step ST207, and if the corresponding evaluation value of the placement candidate position having the largest evaluation value is determined the threshold or more at step ST208, the map object B is moved to the corresponding placement candidate position.

In FIG. 12(c), the relocated position of the map object C having a higher display following the map object B is determined.

First, similar to the map object B, placement candidate positions are set in the vicinity of the map object C, and the evaluation values of the set placement candidate positions are calculated. At this time, if the parameter indicating presence or absence of the overlapping with the placed map object B is contained in the parameters of the evaluation function, the evaluation values of the set placement candidate positions of the map object C are set in consideration of the overlapping with the placed map object B.

For example, if the map object C is placed at one place of the placement candidate positions within the movable area of the map object C, when there is an overlapping with the placed map object B, the value of the above parameter in the evaluation function at the placement candidate position is lowered, so that the evaluation value of the placement candidate position is set lower. This lowers the possibility to be relocated at such a placement candidate position, which enables to prevent the overlapping with the placed map object B.

Subsequently, similar to FIG. 12(c), the relocated positions of the map objects A and D each are determined; the aspects are shown in FIG. 12(d) and FIG. 12(e). In this way, all the map objects are relocated.

As described above, according to Embodiment 1, the evaluation value that is the index for determining the appropriate position as the position for relocating the map object is set to the corresponding placement candidate positions; from among the placement candidate positions set for the map objects that come later in the order of display, the placement candidate position in which the evaluation value indicative of being most appropriate as the position to be relocated is set is extracted, and then whether or not the map object that comes later in the order of display is adapted to a likely placement at the corresponding placement candidate position is determined; and the map object is relocated at the placement candidate position that is determined the likely placement and drawn.

In doing so, the relocated position of the not-placed-yet map object can be determined without moving the map object placed earlier in the order of display (placed map object). For this reason, the time required for calculations of placement of the map objects is linear to the number of the map objects, which enables to determine the relocated position at a high speed.

In addition, according to Embodiment 1, the placement candidate position setting unit 105 divides in a grid the surrounding area of the reference point provided proper to the map object, and sets the grid point within the corresponding surrounding area as the placement candidate position. In doing so, a plurality of placement candidate positions can be set easily.

Moreover, according to Embodiment 1, the evaluation value setting unit 106 calculates the evaluation value using the evaluation function having at least parameters with respect to the following: the position of the map object placed earlier in the order of display; the distance between the reference point provided proper to the map object to be placed later in the order of display and the placement candidate position; presence/absence of the overlapping between the map objects placed earlier and later in the order of display; the overlapping probability between the map objects placed earlier and later in the order of display; the overlapping probability between the predetermined area for setting the placement candidate position of the map object to be placed later in the order of display and the object placed earlier in the order of display, and then sets the resultant to the placement candidate position of the object that comes later in the order of display. In doing so, in the map objects earlier and later in the order of display, not only the presence/absence of the overlapping between the map objects, but also whether or not there is a predetermined positional relationship therebetween can be evaluated.

Further, according to Embodiment 1, the likely placement determining unit 107 extracts the placement candidate position that is set by the evaluation value indicative of being most appropriate as the position to be relocated, from among the placement candidate positions that are set for the object that comes later in the order of display, and then determines whether or not the object that comes later in the order of display is adapted to the likely placement at the corresponding placement candidate position, in accordance with the results of the comparison between the evaluation value of the corresponding placement candidate position and the threshold that is defined for each display scale; and when the placement candidate position is determined an impossible placement, the object in which the corresponding placement candidate position is set is removed (deleted) from drawing targets, and therefore, the map objects can be placed in the order of display so as not to overlap each other while the map objects of the impossible placement are removed.

### Embodiment 2

In the above Embodiment 1, when there are no placement candidate positions complying with the likely placement without overlapping with the placed map object, the map object to be placed at the corresponding position is deleted.

In contrast, in Embodiment 2, in order to relocate as many map objects as possible at a high speed, when there are no placement candidate positions that can be placed without overlapping with a placed map object, the following processing is carried out: the relocation processing is done over by increasing the number of settings of the placement candidate positions.

It is noted that the configuration of the object relocation device in Embodiment 2 is basically the same as that of Embodiment 1 described with reference to FIG. 1; however, there is a difference in that in the processings of a placement candidate position setting unit 105 and a likely placement determining unit 107, when the corresponding evaluation value of the placement candidate position having the largest evaluation is not a threshold or more, the number of settings of the placement candidate positions is increased to do over the relocation by forming a new movable area on the periphery of the corresponding movable area. For this reason, in the following description, the configuration of the object relocation device in Embodiment 2 is referred to FIG. 1.

Next, the operation will be described.

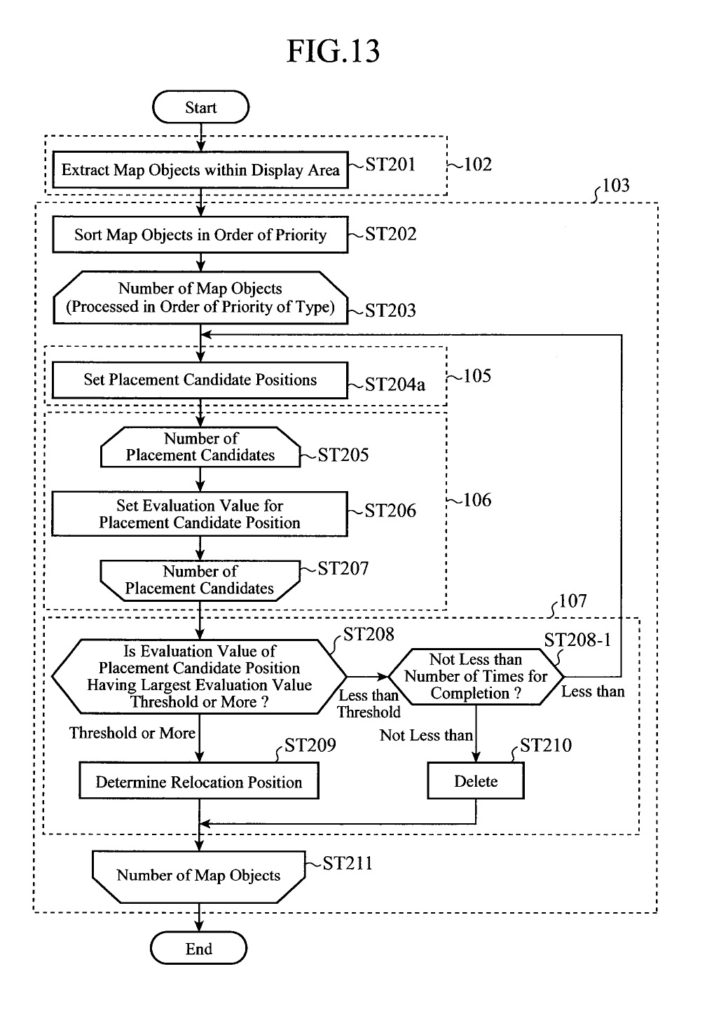

FIG. 13 is a flowchart showing the flow of operations by the object relocation device of Embodiment 2, and shows the operations by a control unit 102 and a map object relocating unit 103.

In FIG. 13, the processing of a section enclosed with a broken line and denoted by reference numeral 102, similarly to FIG. 2, is carried out by the control unit 102, while the processing of a section enclosed with a broken line and denoted by reference numeral 103 is carried out by the map object relocating unit 103.

Then, the processing of a section enclosed with a broken line and denoted by reference numeral 105 is carried out by the placement candidate position setting unit 105 of the map object relocating unit 103, the processing of a section enclosed with a broken line and denoted by reference numeral 106 is carried out by the evaluation value setting unit 106, and the processing of a section enclosed with a broken line and denoted by reference numeral 107 is carried out by the likely placement determining unit 107.

However, in FIG. 13, the steps of performing the same processings as those of FIG. 2 are denoted by the same step numbers, and descriptions thereof will be omitted.

As in FIG. 2, at step ST208, the likely placement determining unit 107 determines whether or not the evaluation value of the placement candidate position having the largest evaluation value is not less than a threshold in accordance with the current display scale of a map. Here, if the corresponding evaluation value of the placement candidate position is the threshold or more, the likely placement determining unit 107 determines the corresponding placement candidate position as a position to be relocated (step ST209). On the other hand, if the corresponding evaluation value of the placement candidate position is less than the threshold, the process proceeds to a processing of step ST208-1.

At step ST208-1, the likely placement determining unit 107 counts the number of times subjected to the proceeding of the step ST208-1, and determines whether or not the number of times of the processing is not less than a preset number of times for completion. At this time, if the number of times of the processing is not less than the number of times for completion, the likely placement determining unit 107 deletes the corresponding map object from drawing targets at step ST210.

If the number of times of the processing is less than the number of times for completion at step ST208-1, the process goes back to the processing of step ST204a.

At step ST204a, the placement candidate position setting unit 105 forms a new movable area in the vicinity of the previous movable area to reset or reestablish placement candidate positions within the corresponding movable area, and the evaluation value setting unit 106 and the likely placement determining unit 107 repeat the processings from step ST205 to step ST208.

Incidentally, as a resetting method of the placement candidate positions, among from the placement candidate positions set within the previous movable area, the new movable area is formed in a direction of the placement candidate position having a larger value from the reference point, and the new placement candidate positions may be set in a manner similar to the previous one.

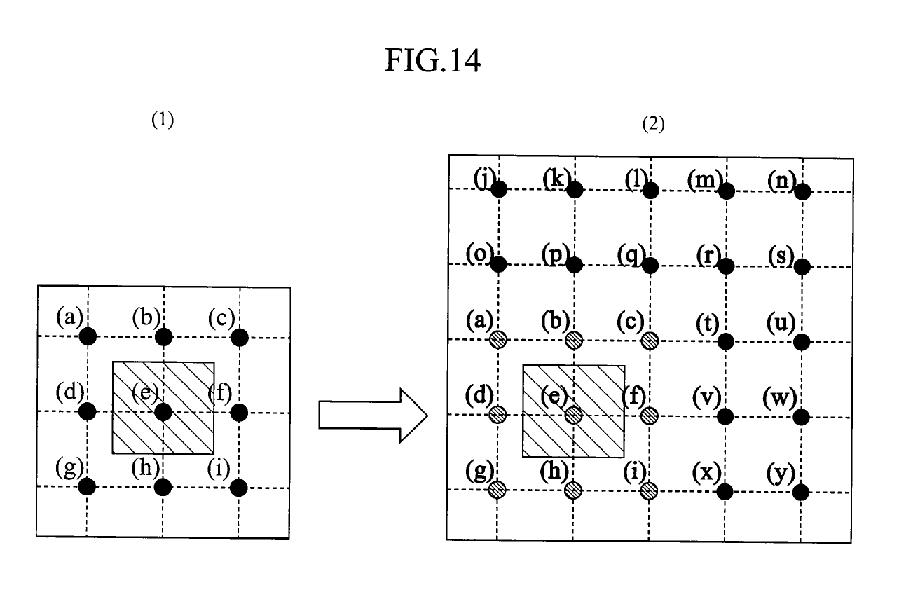

FIG. 14 is a diagram showing one example of the resetting of the placement candidate positions. FIG. 14(1) shows the following instance: the movable area is divided in a grid, the reference point is placed on the grid point at the center thereof, and the placement candidate positions are placed on the grid points on the periphery thereof. When the likely placement determining unit 107 determines that there is no position in which the map object is to be relocated (drawn) in the placement candidate positions in FIG. 14(1), the process goes back to step ST204a.

In the example shown in FIG. 14(2), the placement candidate position setting unit 105 forms a new movable area in a direction of the placement candidate position having a larger value from the reference point within the moving area shown in FIG. 14(1); the corresponding movable area is divided into a grid in a manner similar to FIG. 14(1); and new placement candidate positions (j) to (y) are set on grid points other than the previous (first time) placement candidate positions (a) to (i).

In this way, the processings from step ST205 to step ST208 is carried out to each of the new placement candidate positions (j) to (y) (placement candidate positions at the second time).

Unless the predetermined number of times for completion is reached at step ST208-1, a new movable area is formed similarly from then onwards, and the same processing is performed to the placement candidate positions newly set within the corresponding movable area.

As described above, according to Embodiment 2, the placement candidate position setting unit 105 sets the placement candidate positions within the surrounding area (movable area) of the reference point provided proper to the object that comes later in the order of display; If all the placement candidate positions set within the corresponding movable area are determined impossible placements by the likely placement determining unit 107, a new area is formed in the vicinity of the corresponding movable area, and a placement candidate position is newly set within the corresponding new area. In doing so, when there is no placement candidate positions that can be relocated, relocatable locations can be searched with an increase of the placement candidate positions, so that many map objects can be relocated at no overlapping positions.

### INDUSTRIAL APPLICABILITY

The object relocation device of the present invention can determine the positions for relocating objects at a high speed by reducing the number of times for determining the placed positions of the objects, and thus is suitable for a map display device of a car navigation system.

1. An object relocation device in which a plurality of objects are relocated at no overlapping positions to be displayed, the device comprising:
a database for storing said plurality of objects associated with an order of display;
a placement candidate position setting unit for setting a placement candidate position for the object obtained from said database;
an evaluation value setting unit for setting an evaluation value to said placement candidate position, said evaluation value being an index for determining an appropriate position as a position for relocating said object;
a likely placement determining unit for extracting a placement candidate position that is set by an evaluation value indicative of being most appropriate as a position to be relocated, from among placement candidate positions that are set for the object that comes later in said order of display, and determining whether or not the object that comes later in said order of display is adapted to a likely placement at the corresponding placement candidate position; and
a drawing unit for relocating said object at the placement candidate position that is determined the likely placement by said likely placement determining unit and making a drawing.

2. The object relocation device according to claim 1, wherein said placement candidate position setting unit divides in a grid an surrounding area of a reference point provided proper to said object, and sets a grid point within the corresponding surrounding area as the placement candidate position.

3. The object relocation device according to claim 1, wherein said evaluation value setting unit calculates the evaluation value using an evaluation function having at least parameters with respect to the following:
a position of an object placed earlier in said order of display;
a distance between a reference point provided proper to an object to be placed later in said order of display and said placement candidate position;
presence/absence of an overlapping between the objects placed earlier and later in said order of display;
an overlapping probability between the objects placed earlier and later in said order of display;
an overlapping probability between a predetermined area for setting said placement candidate position of an object to be placed later in said order of display and the object placed earlier in said order of display, and
and then sets the resultant to said placement candidate position of the object that comes later in said order of display.

4. The object relocation device according to claim 1, wherein when said likely placement determining unit extracts the placement candidate position that is set by the evaluation value indicative of being most appropriate as the position to be relocated, from among the placement candidate positions that are set for the object that comes later in said order of display, and then determines whether or not the object that comes later in said order of display is adapted to the likely placement at the corresponding placement candidate position, in accordance with the results of the comparison between said evaluation value of the corresponding placement candidate position and a threshold that is defined for each display scale; and when said placement candidate position is determined an impossible placement, the object in which the corresponding placement candidate position is set is removed from drawing targets.

5. The object relocation device according to claim 1, wherein said placement candidate position setting unit sets the placement candidate positions within a surrounding area of a reference point provided proper to the object that comes later in said order of display, and if all the placement candidate positions set within the corresponding movable area are determined impossible placements by said likely placement determining unit, a new area is formed in the vicinity of the corresponding movable area, and the placement candidate position is newly set within the corresponding new area.

6. A method of relocating objects in an object relocation device including a map database for storing a plurality of map objects associated with an order of display, a placement candidate position setting unit, an evaluation value setting unit, a likely placement determining unit, and a drawing unit, the method comprising:
a step of setting, by said placement candidate position setting unit, a placement candidate position for the map object obtained from said map database;
a step of setting, by said evaluation value setting unit, an evaluation value at said placement candidate position, said evaluation value being an index for determining an appropriate position as a position for relocating said map object;
a step of extracting, by said likely placement determining unit, a placement candidate position that is set by an evaluation value indicative of being most appropriate as a position to be relocated, from among placement candidate positions that are set for the map object that comes later in said order of display, and determining whether or not the map object that comes later in said order of display is adapted to a likely placement at the corresponding placement candidate position; and
a step of relocating, by said drawing unit, said map object at the placement candidate position that is determined the likely placement by said likely placement determining unit, and making a drawing.

7. A program for functioning a computer as an object relocation device relocating a plurality of objects at no overlapping positions and displaying the objects, the device comprising:
a database for storing said plurality of objects associated with an order of display;
a placement candidate position setting unit for setting a placement candidate position for the object obtained from said database;
an evaluation value setting unit for setting an evaluation value to said placement candidate position, said evaluation value being an index for determining an appropriate position as a position for relocating said object;
a likely placement determining unit for extracting a placement candidate position that is set by an evaluation value indicative of being most appropriate as a position to be relocated, from among placement candidate positions that are set for the object that comes later in said order of display, and determining whether or not the object that comes later in said order of display is adapted to a likely placement at the corresponding placement candidate position; and
a drawing unit for relocating said object at the placement candidate position that is determined the likely placement by said likely placement determining unit and making a drawing.
